(19) United States
(12) Patent Application Publication
(10) Pub. No.: US 2008/0123793 A1
(43) Pub. Date: May 29, 2008

(54) Thermal power production device utilizing nanoscale confinement

(76) Inventors: James F. Loan, Bellows Falls, VT (US); William K. Cooper, Santa Fe, NM (US); Christopher H. Cooper, Windsor, VT (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/730,950

(22) Filed: Apr. 5, 2007

Related U.S. Application Data
(60) Provisional application No. 60/789,161, filed on Apr. 5, 2006.

(51) Int. Cl. G21G 1/00

(52) U.S. Cl. 376/156; 977/902

(57) ABSTRACT

Disclosed herein is a device for generating thermal energy through a nuclear transmutation reaction when a hydrogen containing fuel comes into contact with a nanotube containing element in a reaction vessel for containing the nuclear transmutation reaction. The device further includes an energy absorption vessel containing an energy absorption fluid that absorbs energetic particles resulting from the transmutation reaction and a heat transfer system for transferring thermal energy of the energy absorption fluid to a working fluid, such as water. A method of generating power using such a device is also disclosed.

This application claims the benefit of domestic priority under 35 U.S.C. §119(e) to U.S. Application No. 60/789,161, filed on Apr. 5, 2006, and is related to U.S. application Ser. Nos. 11/633,524, filed Dec. 5, 2006, which claimed the benefit of domestic priority under 35 U.S.C. §119(e) to 60/741,874, filed Dec. 5, 2005, and 60/777,577, filed Mar. 1, 2006, and is also related to Ser. No. 11/642,759 filed Dec. 21, 2006, which claimed the benefit of domestic priority under 35 U.S.C. §119(e) 60/752,407, filed Dec. 22, 2005, all of which are incorporated by reference herein.

Disclosed herein is a power production device that generates thermal energy by confining the matter within a nanotube structure thereby inducing a nuclear transmutation reaction. Also disclosed are methods of generating energy, such as thermal energy, by using the disclosed device as a nuclear power system.

A need exists for alternative energy sources to alleviate our society's current dependence on hydrocarbon fuels without further impact to the environment. The inventors have developed multiple uses for carbon nanotubes and devices that use carbon nanotubes. The present disclosure utilizes, in a thermal power production device, the unique properties of carbon nanotubes to meet current and future energy needs in an environmentally friendly way.

Devices powered with nanotube based nuclear-power systems could substantially change the current state of power distribution. For example, nanotube based nuclear power systems could reduce, if not eliminate, the need for power distribution networks; chemical batteries; energy scavenger devices such as solar cells, windmills, hydroelectric power stations; internal combustion, chemical rocket, or turbine engines; as well as all other forms of chemical combustion for the production of power.

### SUMMARY OF THE INVENTION

Accordingly, there is disclosed a device for generating thermal energy through a nuclear transmutation reaction when a hydrogen containing fuel contacts one or more nanotubes. The disclosed device comprises a reaction vessel capable of accepting a hydrogen containing fuel and sustaining a nuclear transmutation reaction. In addition, the disclosed device comprises an energy absorption vessel containing an energy absorption fluid, such as molten metal, that absorbs energetic particles resulting from the transmutation reaction. The disclosed device also includes a heat transfer system for transferring thermal energy of the energy absorption fluid to a working fluid, such as water, and ultimately generating steam to drive a turbine.

Also disclosed is a method of generating power using the disclosed device. In one embodiment, the method of generating thermal energy disclosed herein comprises contacting, in a reaction vessel capable of sustaining a nuclear transmutation reaction, a hydrogen containing fuel with at least one nanotube containing element to generate energetic particles from a nuclear transmutation reaction. The disclosed method includes absorbing the energetic particles with an energy absorption fluid in amount sufficient to increase the thermal energy of the energy absorption fluid, and prevent escape of the energetic particles beyond the confine of the reactor, and transferring, via a heat exchanger, the thermal energy of the energy absorption fluid to a working fluid.

### BRIEF DESCRIPTION OF THE DRAWINGS

FIG. 1. is a schematic representation of a system for generating thermal energy according to one embodiment of the invention.

FIG. 2. is a schematic cross-sectional view of one embodiment of one reactor vessel according to the invention.

FIG. 3. is a schematic cross-sectional view of the main reactor vessel of the embodiment of FIG. 2 without the fuel element present.

FIG. 4. is a schematic cross-sectional view of the main reactor vessel of the embodiment of FIG. 2 with the fuel element present.

FIG. 5. is a schematic cross-sectional view of the fuel element loading assembly of the embodiment of FIG. 2 without the fuel element present.

FIG. 6. is a schematic cross-sectional view of one embodiment of a spherical reactor vessel according to the invention.

FIG. 7. is a schematic cross-sectional view of one embodiment of a spherical reactor vessel utilizing a molten metal jacket completely surrounding the reaction vessel.

### DETAILED DESCRIPTION OF THE INVENTION

### A. Definitions

The following terms or phrases used in the present disclosure have the meanings outlined below:

The term “fiber” or any version thereof, is defined as an object of length L and diameter D such that L is greater than D, wherein D is the diameter of the circle in which the cross section of the fiber is inscribed. In one embodiment, the aspect ratio L/D (or shape factor) of the fibers used may range from 2:1 to 10⁹:1. Fibers used in the present disclosure may include materials comprised of one or many different compositions.

The term “nanotube” refers to a tubular-shaped, molecular structure generally having an average diameter in the inclusive range of 25 Å to 100 nm. Lengths of any size may be used.

The term “carbon nanotube” or any version thereof refers to a tubular-shaped, molecular structure composed primarily of carbon atoms arranged in a hexagonal lattice (a graphene sheet) which closes upon itself to form the walls of a seamless cylindrical tube. These tubular sheets can either occur alone (single-walled) or as many nested layers (multi-walled) to form the cylindrical structure.

The term “double-walled carbon nanotube” refers to an elongated solenoid of a carbon nanotube described having a closed carbon cage but at least one open end.

The phrase “environmental background radiation” refers to ionizing radiation emitted from a variety of natural and artificial sources including terrestrial sources and cosmic rays (cosmic radiation).

The phrase “neutron cross section” (with or without the word “capture” contained therein) refers to the effective area within which a neutron passes in order to be captured by an atomic nucleus. Nuclear capture cross section is often measured in barns (1 barn=10⁻²⁴ cm²).

The phrase “a material having as low a neutron cross-section as is practicable” means a material which has a minimal or non-existent neutron cross section that is effective for radiative capture, but which can withstand the transmutation conditions described herein, and thus be used as at least part of the reaction vessel.

The term “functionalized” (or any version thereof) refers to a nanotube having an atom or group of atoms attached to the surface that may alter the properties of the nanotube, such as zeta potential.

The phrase “energetic particle adsorbing material” refers to a material either liquid, molten, or solid that has a sufficiently high capture cross section as to be effective at converting the kinetic energy of a particle to thermal energy.

The term “doped” carbon nanotube refers to the presence of ions or atoms, other than carbon, into the crystal structure of the rolled sheets of hexagonal carbon. Doped carbon nanotubes means at least one carbon in the hexagonal ring is replaced with a non-carbon atom.

The terms “transmuting,” “transmutation” or derivatives thereof is defined as a change of the state of the nucleus, whether its changing the number of protons or neutrons in the nucleus or changing the energy in the nucleus through capture or emission of a particle. Transmuting matter is thus defined as changing the state of the nucleus comprising the matter.

The term “plasma” refers to an ionized gas, and is intended to be a distinct phase of matter in contrast to solids, liquids, and gases because of its unique properties. “Ionized” means that at least one electron has been dissociated from a proportion of the atoms or molecules. The free electric charges typically make the plasma electrically conductive so that it responds strongly to electromagnetic fields.

An “aligned array” refers to an arrangement of carbon nanotubes grown to give one or more desired directional characteristics. For example, an aligned array of surface grown carbon nanotubes typically, but not exclusively, comprise random or ordered rows of carbon nanotubes grown substantially perpendicular to the growth substrate.

The terms “nanostructured” and “nano-scaled” refers to a structure or a material which possesses components having at least one dimension that is 100 nm or smaller. A definition for nanostructure is provided in The Physics and Chemistry of Materials, Joel I. Gersten and Frederick W. Smith, Wiley publishers, pp. 382-383, which is herein incorporated by reference for this definition.

The phrase “nanostructured material” refers to a material whose components have an arrangement that has at least one characteristic length scale that is 100 nanometers or less. The phrase “characteristic length scale” refers to a measure of the size of a pattern within the arrangement, such as but not limited to the characteristic diameter of the pores created within the structure, the interstitial distance between fibers or the distance between subsequent fiber crossings. This measurement may also be done through the methods of applied mathematics such as principle component or spectral analysis that give multi-scale information characterizing the length scales within the material.

“Chosen from” or “selected from” as used herein refers to selection of individual components or the combination of two (or more) components. For example, the nano-structured material can comprise carbon nanotubes that are only one of impregnated, functionalized, doped, charged, coated, and irradiated nanotubes, or a mixture of any or all of these types of nanotubes such as a mixture of different treatments applied to the nanotubes.

In one embodiment, there is disclosed a device for generating energetic particles through a transmutation of isotopes utilizing a nanotube structure. The transmutation reaction is described in co-pending patent application Ser. No. 11/633,524, filed Dec. 5, 2006, which is herein incorporated by reference in its entirety. In general, this type of reaction comprises a change to the nuclear composition of an isotope accompanied by a release or adsorption of energy. In order to generate energy from the combination or division of stable isotopes the addition of activation energy may be required.

This activation energy may come in the form of electromagnetic stimulation either directly or indirectly which imparts momentum temperatures, pressure or electromagnetic fields to the isotope. The initial activation energy may be in the form of a current pulse or electromagnetic radiation. Furthermore, activation energy may come in the form of energy produced from the transmutation reactions described herein, also known as a chain reaction. Thus, in one embodiment, a device according to the present disclosure comprises a lead or inlet to allow this type of activation energy to be applied to the nanotubes or nano-structure contained therein.

In certain isotopic transmutation reactions, activation energy is the energy required to overcome the coulomb repulsion that arises when two nuclei are brought close together. The primary isotope for such a reaction is deuterium (²H), although hydrogen (¹H), tritium (³H), and helium three (³He) can also be used on the way to producing energy and helium four (⁴He). Included by reference is a list of isotopes which can be used for energy producing transmutation reactions and can found on 507-521 of “Modern Physics” by Hans C. Ohanian 1987, which pages are herein incorporated by reference.

In order to overcome the coulomb repulsion of the isotopes required for transmutation, activation energy may be supplied in the form of thermal, electromagnetic, or the kinetic energy of a particle. Electromagnetic energy comprises one or more sources chosen from x-rays, optical photons, α, β, or γ-rays, microwave radiation, infrared radiation, ultraviolet radiation, phonons, cosmic rays, radiation in the frequencies ranging from gigahertz to terahertz, or combinations thereof.

The activation energy may also comprise particles with kinetic energy, which are defined as any particle, such as an atom or molecule, in motion. Non-limiting embodiments include protons, neutrons, anti-protons, elemental particles, and combinations thereof. As used herein, “elemental particles” are fundamental particles that cannot be broken down to further particles. Examples of elemental particles include electrons, anti-electrons, mesons, pions, hadrons, leptons (which is a form of electron), baryons, radio isotopes, and combinations thereof.

Other particles that may be used as activation energy in the disclosed method include those mentioned by reference at pages 460-494 of “Modern Physics” by Hans C. Ohanian, which pages are herein incorporated by reference.

Similarly, the energetic particles generated by the disclosed method may comprise the same energetic particles previously described, namely neutrons, protons, electrons, beta radiation, alpha radiation, mesons, pions, hadrons, leptons, baryons, and combinations thereof. In other words, the energetic particles produced by the disclosed method may comprise the same energetic particles used to initiate the reaction.

Because energy production required for the transmutation reaction described herein typically uses activation energy, one can control the energy produced by controlling the amount of activation energy present or the rate at which the isotopes are being fed in the inventive process to the nanotube structure. For example, the generation of energy can be significantly reduced by freezing a nanotube/heavy water mixture, thus robbing thermal energy from the nuclear transmutation process and slowing diffusion of deuterium into the nanotubes, such as carbon nanotubes.

Without being bound by any theory the methods for generation of energetic particles and transmutation reactions described herein are a manifestation, at least in part, to the nanotube structure. It is believed that when matter on the atomic scale is confined to the limited dimensions of a nanotube structure, the nucleus of the atoms comprising the matter will more likely be subject to interaction and thus transmutation of the matter. In other words, nanoscale confinement increases the probabilities that nuclei of matter will interact. Similar theories have been described as screening in a one-dimensional Bose gas, a description of which can be found in the article by N. M. Bogolyubov et al., Complete Screening in a One-Dimensional Bose Gas, Zapiski Nauchnykh Seminarov Leningradskogo Otdeleniya Matematicheskogo Instituta im. V. A. Steklova AN SSSR, Vol. 150 pp. 3-6, 1986.

Thus, in one embodiment, it is believed that with a high density electron plasma inside the confined system of a carbon nanotube when a current, such as in the form of a pulse, is applied to the carbon nanotube, and in the presence of deuterium, coulomb repulsion may be reduced or eliminated. Electrons may be in very close proximity to the nuclei, thus on average canceling out the coulomb repulsion between deuterium isotopes. This in turn should decrease the required activation energy for transmutation.

With the foregoing in mind, it is realized that any nanoscaled structure having a hollow interior that assists or enables nanoscale confinement, and that is capable of withstanding the internal conditions associated with the disclosed method, can be used within the disclosed device to generate energetic particles.

In one embodiment, the nanotubes that can be used in the disclosed device comprises carbon and its allotropes. For example, the carbon nanotube used according to the present disclosure may comprise a multi-walled carbon nanotube having a length ranging from 500 μm to 10 cm, such as from 2 mm to 10 mm. Nanotube structures according to the present disclosure may have an inside diameter ranging up to 100 nm, such as from 25 Å to 100 nm.

The nanotube material may also comprise a non-carbon material, such as an insulating, metallic, or semiconducting material, or combinations of such materials.

It is to be appreciated that the hydrogen isotopes may be located within the interior of a nanotube, the space between the walls of a multi-walled nanotube (when used), inside at least one loop formed by one or more nanotubes, or combinations thereof.

In one embodiment, the nanotubes may be aligned within the disclosed device end to end, parallel, or in any combination there of. The nanotubes may also form a network of interconnected nanotubes. In one embodiment, the network may include additional fibers chosen from quartz, carbon ceramic, metal and combinations thereof.

In addition, or alternatively, the nanotubes may be fully or partially coated or doped by least one atomic or molecular layer of an inorganic material.

In certain embodiments, the disclosed device and method may further incorporate a catalyst to enhance the disclosed transmutation reaction. This may be done by either choosing a particular nanotube, such as carbon, or by doping or coating the nanotube with a molecule that can alter the amount or type of activation energy needed to initiate the disclosed reactions.

As used herein, “catalyst” or any word derived therefrom, is defined as a substance that changes the activation energy required to initiate or sustain the disclosed reaction. In one embodiment, changing the activation energy is defined as lowering the energy required for transmutation reaction(s) to occur.

When the nanotube structure further acts as a catalyst, it may do so as an integrator, taking many low energy photons, phonons or particles and additively delivering their energy to the transmutation nuclei. The previously mentioned forms of activation energy may also be used in such a process.

In some cases, activation energy may result from the sum of multiple forms of energy, such as x-rays nanotube capture coincident with electron nuclear scattering to drive the transmutation reaction, such as the transmutation of deuterium into ³He and neutrons.

In certain embodiments, it is possible to produce a chain reaction by loading hydrogen isotopes within the nanotube so that energy released from one transmutation event will drive more transmutation events.

As stated, method of transmuting matter may lead to the generation of energy, from the release of energetic particles. In non-limiting embodiments, the energy generated from the disclosed method may comprise neutrons tritons, helium isotopes and protons with kinetic energy.

The nanotube structure disclosed herein may comprise single walled, double walled or multi-walled nanotubes or combinations thereof. The nanotubes may have a known morphology, such as those described in Applicants co-pending applications, including U.S. patent application Ser. No. 11/111,736, filed Apr. 22, 2005, U.S. patent application Ser. No. 10/794,056, filed Mar. 8, 2004 and U.S. patent application Ser. No. 11/514,814, filed Sep. 1, 2006, all of which are herein incorporated by reference.

Some of the above described shapes are more particularly defined in M. S. Dresselhaus, G. Dresselhaus, and P. Avouris, eds. Carbon Nanotubes: Synthesis, Structure, Properties, and Applications, Topics in Applied Physics. 80. 2000, Springer-Verlag; and “A Chemical Route to Carbon Nanoscrolls, Lisa M. Viculis, Julia J. Mack, and Richard B. Kaner; Science, 28 Feb. 2003; 299, both of which are herein incorporated by reference.

When nanotube structures having the foregoing morphologies are employed, the confinement dimension, defined as the dimension in which the matter undergoing transmutation is confined, is chosen from the interior of a nanotube, the space between the walls of a multi-walled nanotube, inside at least one loop formed by one or more nanotubes, or combinations thereof.

It is understood that the nanotube structure that is positioned within the inventive device may comprise a network of nanotubes which are optionally in a magnetic, electric, or otherwise electromagnetic field. In one non-limiting embodiment, the magnetic, electric, or electromagnetic field can be supplied by the nanotube structure itself, such as in the form of alternating current direct current or current pulses to the nanotube structure or combinations thereof.

Thus, in one embodiment there is disclosed a device for generating power using the nanoscale confinement structure of a carbon nanotube to perform nuclear transmutation reactions of fusable materials referred to herein as “reaction fuel.” The reaction fuel may be comprised of isotopes of hydrogen. For example, hydrogen (i.e., protium), deuterium, and tritium may all be used as fuels for exothermic nuclear transmutation reactions. The fuel used in the disclosed device provides a source of ions that are confined in a nanotube structure, thus driving the transmutation reaction.

As stated, it is believed that confining the fuel within a nanotube structure and adding energy to the system allows the atoms within the nanotube structure to overcome the repulsion forces and initiate a nuclear fusion reaction in a transmutation reaction. The disclosed device utilizes the particles released from the transmutation reactions by absorbing them in an energy adsorption fluid. This energy absorption fluid has a capture cross section sufficient to capture substantially all of the energetic particles. The kinetic energy of the particles is transformed to thermal energy by the fluid medium. The energy adsorption fluid is then pumped to a heat exchanger in order to transfer the energy from the fluid medium to a working fluid.

In one embodiment, the energy absorption fluid comprises a molten metal, such as molten sodium, lithium, beryllium, or mercury. Sodium is specifically mentioned because it has a large cross sectional capture coefficient for neutrons which are one of the energetic particles released from the fusion of two deuterium nuclei into a helium three nucleus. The absorption of neutrons by the molten sodium will further heat the molten sodium.

In one embodiment of the device disclosed herein, the energy adsorption fluid may be contained within a vessel hereby known as the energy absorption vessel. The energy absorption vessel may be in a geometric orientation such that a substantial number of energetic particles will impinge on the energy absorption vessel. For example, the energy absorption vessel may partially surround, or fully envelope, the reaction chamber, such that substantially all energetic particles generated in the reaction chamber impinge upon the energy absorption fluid in the energy absorption vessel.

The energy adsorption fluid may be circulated through a heat exchanger in a closed loop system. Fluid transfer piping may be used to transfer the energy adsorption fluid from the fluid pump, such as a magneto hydrodynamic pump, to the adsorption vessel to the heat exchanger and back to the fluid pump in a closed loop.

In one embodiment, a molten sodium to water heat exchanger is used for the transfer of thermal energy. In this embodiment, the heated energy adsorption fluid can be pumped into a heat exchanger where the energy will be used to convert water to steam, which can then drive a turbine. In addition, the transfer piping, heat exchanger, and all the sodium-wetted surfaces may be heated so that the energy absorbing sodium medium is maintained in the molten state.

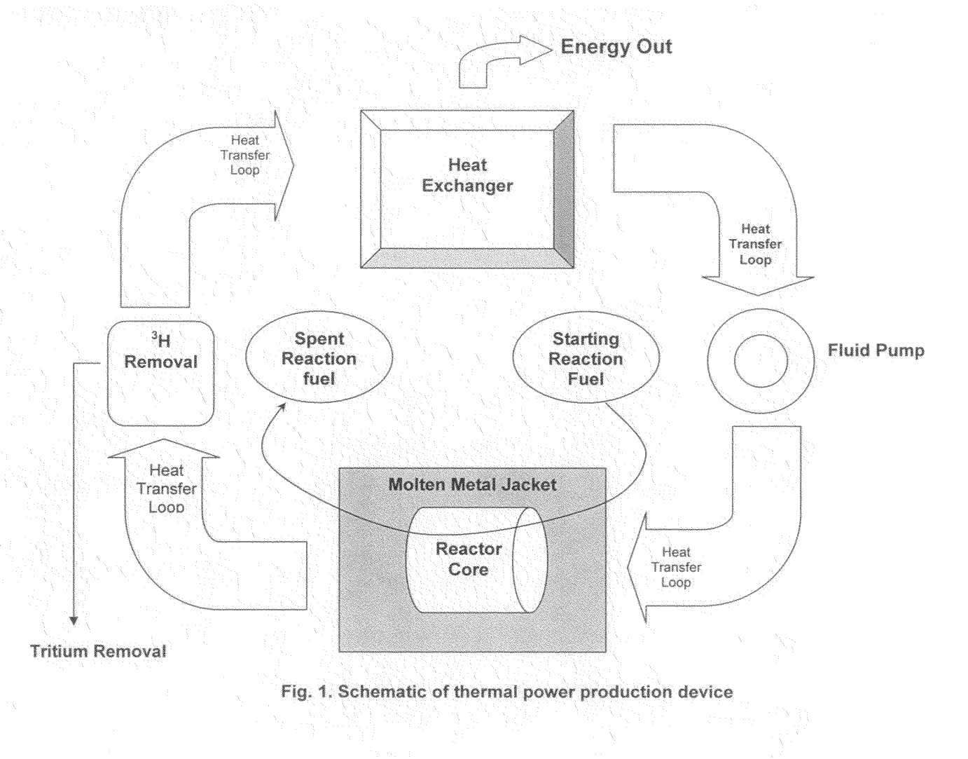

As depicted schematically in FIG. 1, reaction fuel is introduced into the reactor core, which is surrounded by a jacket with molten metal between the core and the jacket. When the reaction fuel is spent it, and gaseous reaction products are removed from the core, for example, those products entrained in the molten metal The molten metal is transported by a suitable pump and is in flow communication with a heat exchanger were the heat from the molten metal coolant is transferred to a working fluid.

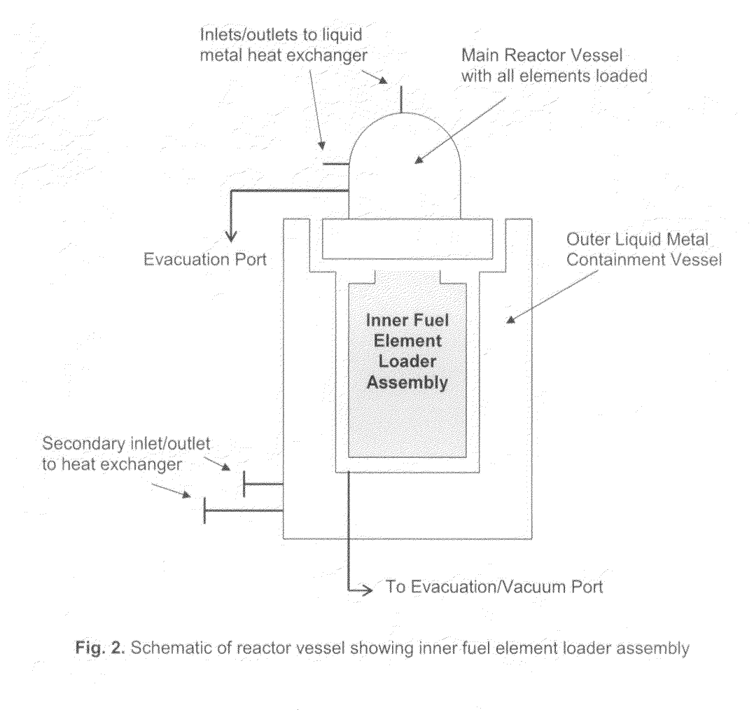

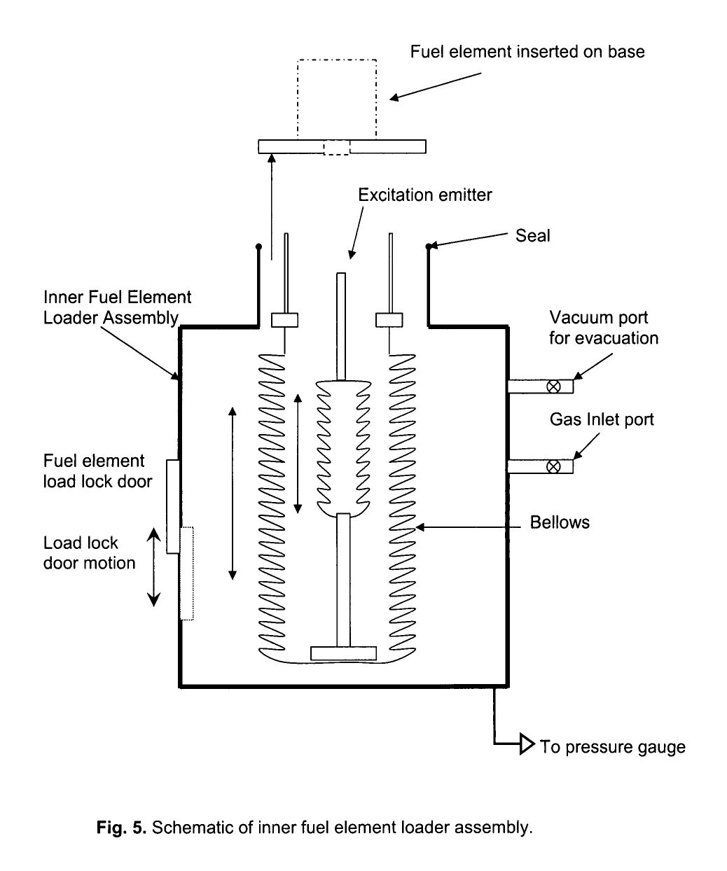

FIG. 2 schematically depicts the cross sectional view of an embodiment of the reactor where the hemispherical upper main reactor vessel is surrounded by the jacket described above and includes an extractor for the gas from the molten metal coolant. The inner fuel element loading assembly (depicted in more detail in FIG. 5) is surrounded by a liquid metal containment vessel, which may also have a liquid metal coolant surrounding it. The interior of the liquid metal containment vessel is in flow communication with a vacuum source so the interior of the liquid metal containment vessel, and the main reactor vessel that is in flow communication therewith can be evacuated if necessary. The liquid metal in the liquid metal containment vessel is also in flow communication with a heat exchanger.

The disclosed device may be equipped with numerous safety features to stop a reaction within the reaction vessel. For example, a vacuum source, such as a vacuum dump vessel, may be connected to the reaction chamber through a closed valve to be used as a way to stop power output in an emergency by reducing the concentration of fuel.

In another embodiment, a closed-loop pressure controller is used to control the hydrogen isotope gas pressure which in turn controls the transmutation reaction rates during normal operation. It is also possible to use radiation hardened controls in any device in proximity to the transmutation reaction. In one embodiment, the nuclear transmutation reaction vessel is used to contain the nuclear transmutation reactions. This vessel may be made of quartz because quartz has at least two properties that are particularly advantageous for this type of reaction. First, it will withstand high temperature without deformation or the loss of integrity. Second, quartz has a low neutron cross-sectional capture. For this reason it will survive for extended periods of time in a high radiation zone. When the inner vessel is quartz, tritium and He³ may migrate through the quartz into the sodium and out again through the palladium window.

The inner vessel may also be made of a more robust material, such as a metal, including steel. Depending on the metal used for the inner vessel, less helium and hydrogen isotopes will make their way through the metal vessel compared to the quartz vessel.

It is to be appreciated that tritium is produced in the reactor and can be produced in the energy adsorption fluid as a byproduct of the nuclear transmutation reaction. Tritium is very valuable making it is advantageous to harvest this radioisotope. To separate the tritium from the energy adsorption fluid, the device described herein may comprise a gas absorbtion/desorbtion device sufficient to capture tritium. An example of such a device is made of a metal that forms weakly bonded chemical compounds with hydrogen and tritium. Examples of such metals are palladium, titanium, zirconium, and uranium. The tritium can be released by heating the weakly bonded compound to a temperature sufficient to decompose the particular compound used. It is also possible to use a palladium member (at a particular temperature and pressure) to confine the pressurized molten sodium within the closed heat transfer system with the tritium being extracted through the palladium member.

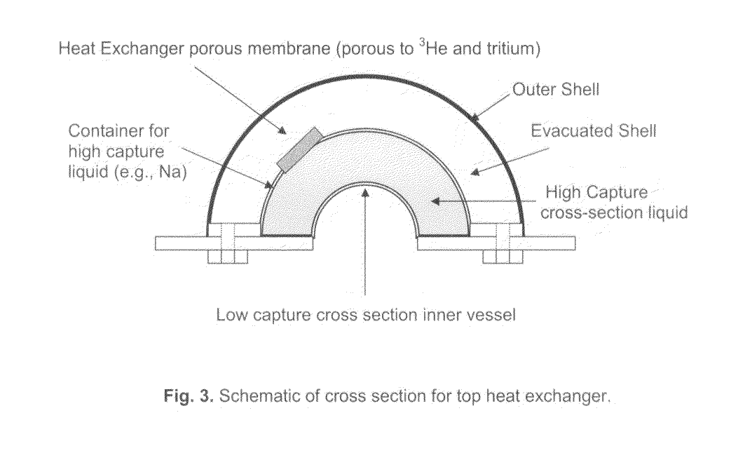

As here embodied in FIG. 3, the main reactor vessel, which is surrounded by high capture cross section liquid, includes a gas permeable member for the extraction of the gases formed within the high capture cross section liquid. The space between the container for the high capture cross section liquid and an outer shell is evacuated to provide thermal insulation, and to provide containment of the high capture cross section liquid if the containment of that material fails.

The reaction fuel used in the disclosed device is in a gaseous form. In one embodiment, the fuel is introduced into the reaction chamber through a gas inlet for introducing the gaseous reaction fuel such that it can come into contact with the carbon nanotubes in the reaction chamber.

In another embodiment, the gaseous reaction fuel is introduced into the reaction chamber and ionized to form a fuel plasma. Therefore, the device described herein may include an ionizer to ionize the isotopes of hydrogen within the reaction chamber and maintain this plasma state. The ionization energy could be generated from a DC or AC field produced from an external power supply and internal electrodes, or it may come from the ionizing radiation of the fusion process. In one embodiment, the reactor includes an RF generator to induce a plasma in the gas inside the reactor around the fuel element. The gas inside the reactor may range from a millibar or less to several bar. The fusion process generates x-rays and gamma rays, which may also induce or maintain a plasma.

In another embodiment, the fuel plasma may be thermally implanted into at least one nanotube. For example the fuel plasma can be heated using an RF generator such that the RMS velocity of the fuel plasma is sufficient to imbed a flux of reaction fuel ions into the nanotubes.

In one embodiment, the nanotubes used in the disclosed device are within a cartridge prior that is inserted into the reactor. Such a cartridge, which may be expendable and would facilitate the insertion and removal of nanotubes from the apparatus.

In the embodiment where the nanotubes consist essentially of carbon, the carbon nanotubes may take a form chosen from: hollow multi-walled carbon nanotubes, bamboo multi-walled carbon nanotubes, double-walled carbon nanotubes, single-walled carbon nanotubes, carbon nano-horns, carbon nano-spirals, carbon nanotube Y-junctions, or other carbon nanotube species.

The reaction fuel cartridge may comprise a surface on which nanotubes can be grown. For example, when the nanotubes comprise carbon, the resulting carbon nanotube structure will be referred to as surface grown carbon nanotubes. At least one of the surfaces of the nanotube structure can be used as part of the cartridge device. In this embodiment, the carbon nanotubes are grown from the growth surface, referred to as the substrate.

Typically, surface grown carbon nanotubes are achieved by first depositing a thin layer of catalyst such as iron or nickel, on the substrate. Through a chemical vapor deposition process using a carbon containing precursor, crystallization of carbon nanotubes begin on the catalytic surface. The end of the carbon nanotube grown from and attached to the substrate will be referred to as the base. The end of the carbon nanotube distal from the substrate is referred to as the head.

For example, in one embodiment, there is disclosed a method for producing a plurality of surface-grown aligned carbon nanotubes on a substrate that can be used in the disclosed device. In one embodiment, the method comprises depositing onto a substrate,

(1) a catalyst support material,

(2) a release or growth promotion layer, typically comprising a metal or metal oxide, such as an oxide of silicon or aluminum,

(3) a catalyst to initiate and maintain the growth of carbon nanotubes, and

(4) a carbon-bearing precursor,

wherein (1)-(4) are performed in the same or separate deposition zones.

Additionally, the method may use an inert carrier gas for one of (1) to (4), such as argon, nitrogen, hydrogen, or any combination of such gases. Alternatively, the carrier gas may comprise a pure gas, such as pure argon, pure nitrogen, or pure hydrogen.

Additionally, the method may use an inert carrier gas for one of (1) to (4), such as argon, nitrogen, hydrogen, or any combination of such gases. Alternatively, the carrier gas may comprise a pure gas, such as pure argon, pure nitrogen, or pure hydrogen.

In one embodiment, devices may be used to impart sufficient activation energy into the nanotube deuterium system to stimulate nuclear fusion. Such devices may be chosen from but not limited to filaments, x-ray machines, antennas, magnets, accelerating electrode systems, ionizers, power supplies, capacitors, Van de Graaff generators, nanotube particle generators, lasers, microwave generators, and ohmic heating elements.

In one embodiment, etching may be used to remove the end caps from the heads of carbon nanotubes. By having the head open hydrogen isotope ions may more readily be absorbed into the center of the carbon nanotube.

In another embodiment, the substrate is either a conductor itself or has a layer of conducting metal between the base of the surface grown carbon nanotube and the substrate.

In another embodiment, the nanotubes are comprised of multi-wall carbon nanotubes, single walled carbon nanotubes, bamboo carbon nanotubes, spiral carbon nanotubes, and combinations thereof.

The carbon nanotubes may be grown randomly or as an aligned array on the substrate. As used herein, an “aligned array” is defined as nanotubes that are substantially aligned in the same direction. In one embodiment, the direction is substantially perpendicular to the substrate.

The structured nanotube-carrying fuel element according to the present disclosure may be comprised of a tubular quartz element with a forest of carbon nanotubes grown on the inside surface, a flat surface of quartz with a forest of carbon nanotubes grown one at least one surface.

The carbon nanotubes maybe functionalized with at least one organic group during or after the growth cycle. Functionalization is generally performed by modifying the surface of carbon nanotubes using chemical techniques, including wet chemistry or vapor, gas or plasma chemistry, and microwave assisted chemical techniques, and utilizing surface chemistry to bond materials to the surface of the carbon nanotubes. These methods are used to “activate” the carbon nanotube, which is defined as breaking at least one C-C or C-heteroatom bond, thereby providing a surface for attaching a molecule or cluster thereto.

Functionalized carbon nanotubes may comprise chemical groups, such as carboxyl groups, attached to the surface, such as the outer sidewalls, of the carbon nanotube. Further, the nanotube functionalization can occur through a multi-step procedure where functional groups are sequentially added to the nanotube to arrive at a specific, desired functionalized nanotube.

Unlike functionalized carbon nanotubes, coated carbon nanotubes are covered with a layer of material and/or one or many particles which, unlike a functional group, is not necessarily chemically bonded to the nanotube, and which covers a surface area of the nanotube. For example, in one embodiment, the nanotube structure disclosed herein may have a epitaxial layers of metals or alloys.

Carbon nanotubes used herein may also be doped with constituents to assist in the disclosed process. As stated, a “doped” carbon nanotube refers to the presence of ions or atoms, other than carbon, into the crystal structure of the rolled sheets of hexagonal carbon. Doped carbon nanotubes means at least one carbon in the hexagonal ring is replaced with a non-carbon atom.

As stated, the fuel used in the disclosed device provides a source of ions that are implanted into the nanotube structure, thus driving the transmutation reaction. The mechanism by which the ions from the fuel are implanted into a nanotube structure may vary. For example, ions can be introduced into a nanotube through absorption, implantation, quantum tunneling, permeation, or any another transport method.

Furthermore without being bound by theory, when the nanotube is made from carbon, it is believed that the large number of electron states within the carbon nanotube may cause coulomb shielding, thus reducing the repulsive electric field between two nuclei, which further enhances the possibility of a fusion event. In other words, this effect would decrease the amount of energy needed to fuse the two nuclei into one and liberate energetic particles.

The device according to the present disclosure typically includes a pump for evacuation of the reaction chamber. It is understood that the reaction chamber may be sealed from the environment by one or more load locks that are used for introducing and removing nanotube cartridges, for example.

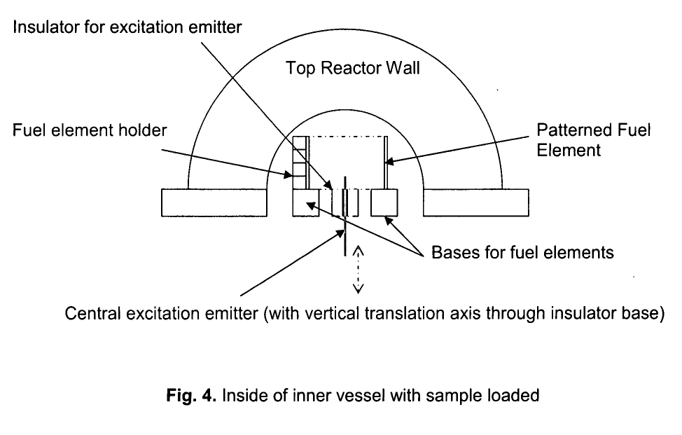

As here embodied, such a cartridge with nanotubes on a substrate is schematically depicted in the main reactor vessel in FIG. 4. A cylindrical fuel element holder (substrate) has affixed on its inner surface a plurality of nanotubes, shown in FIG. 4 as the patterned fuel element. The cartridge is placed in the main reactor vessel by a inner fuel element loader assembly, also shown in FIGS. 2 and 5. In the presence of reaction fuel and nanotubes, the introduction of energy into the main reactor vessel by the excitation emitter induces the nuclear reaction within the main reactor vessel.

One embodiment of the fuel element is a separately device comprised of nanotube attached to a substrate packaged into a fuel cartridge. The substrate may be comprised of plates, platelets, particles, fibers, and ribbons made of materials chosen from fused silica, quartz, metals, ceramics, allotropes of carbon.

In another embodiment the fuel cartridge contains nanotubes pre-charged with isotopes of hydrogen sequestered in the nanotube.

One embodiment of the fuel element loader is schematically depicted in FIG. 5. It includes a load lock door for introducing a fuel element into the loader on top of the outer bellows, with the excitation emitter protruding there through. By introducing gas to the loader the fuel element can be lifted vertically into the main reactor vessel. By manipulating the pressures between the inner and outer bellows, the central excitation member can be raised vertically to enter the main reactor vessel inside the cylindrical fuel element. Venting of gas pressure within the loader results in both the exciter and the fuel element moving out of the main reactor vessel.

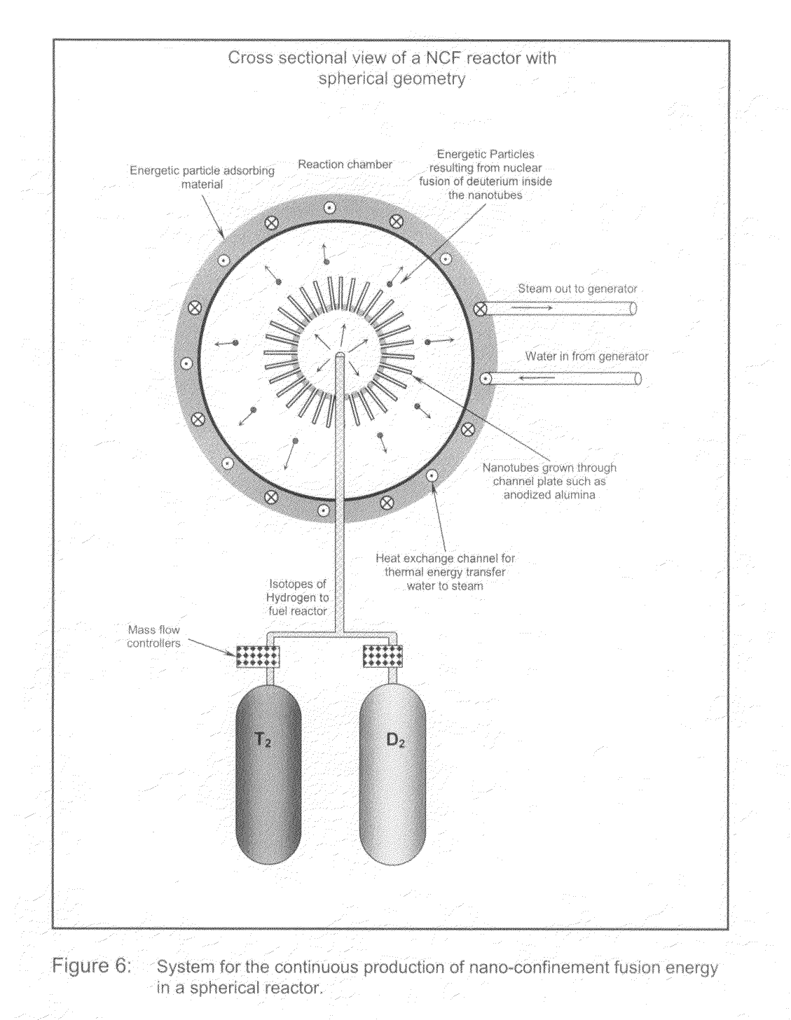

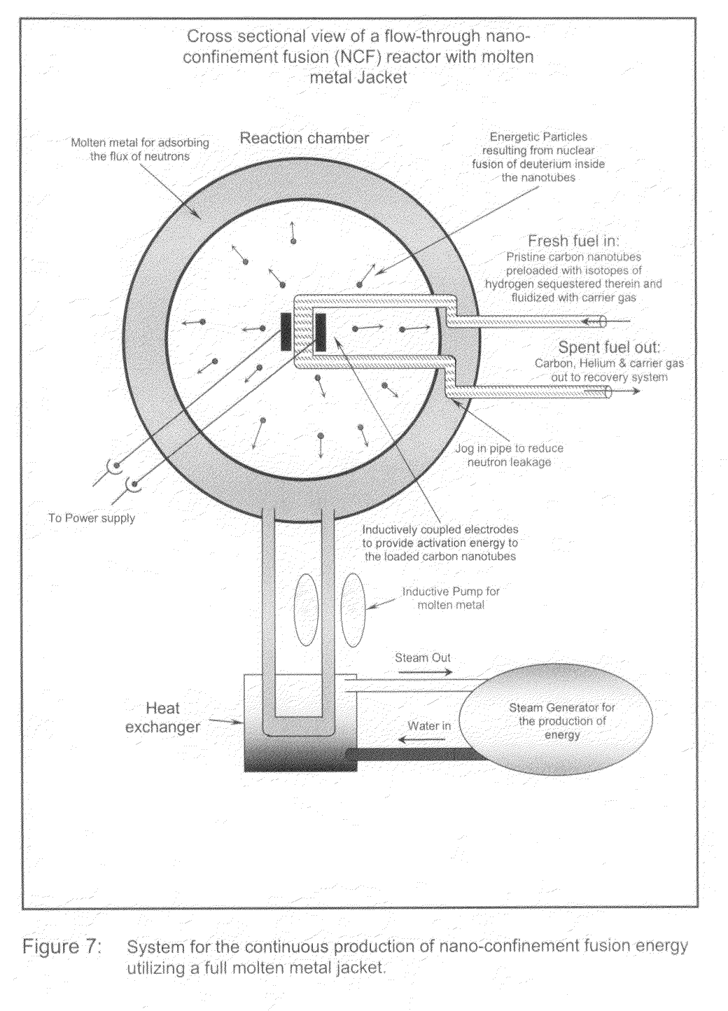

In another embodiment, there is disclosed a reactor or system for the continuous production of nano-confinement energy. This can be done in a spherical reactor, such as those exemplified in FIGS. 6 and 7.

FIG. 6, for example, shows a spherical reaction chamber completely surrounded by an energy absorbing material as described herein. In this embodiment, there is a continuous flow of fuel to the reaction chamber to the nanotubes located in the chamber. The energy transfer system for absorbing energetic particles from the transmutation reaction not only includes the energy absorbing material, but also heat exchange channels which assists in the transfer of heat to the formation of steam.

Similarly, FIG. 7 shows a spherical reaction chamber utilizing a molten metal jacket completely surrounding the reaction vessel. This figure shows various embodiments of how the reaction fuel can be circulated through the reaction chamber, as well as how steam can be generated from the reactor.

Also disclosed herein is a method of generating energy using the device disclosed herein. For example, it is possible for the inventive device to operate in a cyclical manner after system start up.

The method would typically begin by evacuating the reaction chamber, heating the energy adsorption fluid, such as sodium, to a molten state, and pumping the molten sodium within the energy transfer subsystem. The energy transfer subsystem further includes a heat exchanger for transferring the thermal energy from the energy absorption fluid to a working fluid. For example, in one embodiment, a molten sodium to water heat exchanger is used for the transfer of thermal energy. Fluid transfer piping is used to transfer the energy adsorption fluid from the adsorption vessel to the heat exchanger and back to the fluid pump in a closed loop. The transfer piping may be heated so that the energy absorption fluid is maintained in the molten state.

The nanotube bearing cartridge may then be introduced into the reaction chamber through a load lock. This loading process can be performed manually or can be automated. While in the load lock stage, the nanotube cartridge, such as one containing carbon nanotubes, may be heated in a vacuum in order to degas the cartridge.

Once the nanotube bearing cartridge is introduced into the reaction chamber, reaction fuel is introduced into the reaction vessel. In one embodiment, such isotopes are introduced as a gas, and are ionized after being introduced. The ionization adds initiation energy to drive the fusion process, thereby increasing carbon nanotube ion absorption. Ionization also produces a charged gas that can optionally be directed toward the carbon nanotubes with an electric potential for ion implementation of the ions into the carbon nanotubes. In other embodiments energy (such as light energy) is impinged on the reaction fuel and nanotubes to induce the nuclear transmutation process and in other embodiments the radiation from the nuclear transmutation process itself will ionize the reaction fuel.

In the disclosed process, after the reaction fuel (e.g. hydrogen isotopes) reach the center of the nanotubes a nuclear transmutation process is initiated, thus creating energetic particles. In one embodiment, the hydrogen isotopes would continue to feed into the reaction chamber at a rate that will sustain power output. The reaction intensity may be controlled by changing the concentration of reaction fuel in the plasma. The nuclear transmutation process may be terminated by venting the reaction fuel into an evacuated chamber isolated from the nanotubes.

Ionization of the reaction fuel may be maintained throughout the energy production process.

Without being bound by any theory, it is believed that the nanotubes will eventually be destroyed by the flux of particles created by the nuclear transmutation reactions. As a result, this expendable element may need to be replaced periodically with a new cartridge, which can be done through the load lock stage.

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention.

Other embodiments of the invention will be apparent to those skilled in the art from consideration of the specification and practice of the invention disclosed herein. It is intended that the specification and examples be considered as exemplary only, with the true scope of the invention being indicated by the following claims.

What is claimed is:

1. A device for generating thermal energy from a nuclear transmutation reaction, said device comprising:
a reaction vessel for receiving reaction fuel, the reaction vessel being capable of withstanding a nuclear transmutation reaction;
one or more nanotubes located in said reaction vessel disposed to contact at least one nanotube with the reaction fuel;
a source of energy to energize the reaction fuel within the at least one nanotube to initiate the transmutation reaction; and
an energy transfer system for absorbing energetic particles from the transmutation reaction.

2. The device of claim 1, wherein said reaction vessel comprises quartz.

3. The device of claim 1, further comprising at least one loading stage for loading and/or unloading the nanotube containing element.

4. The device of claim 1, further comprising a transport system for transporting the reaction fuel, nanotubes or combinations thereof into and through the reaction vessel via a gas, liquid, or supercritical fluid.

5. The device of claim 1, wherein the energy transfer system is comprised of a material for absorbing energetic particles and an energy transfer fluid.

6. The device of claim 1, wherein the reaction fuel comprises at least one isotope chosen from hydrogen, deuterium, tritium, and combinations thereof.

7. The device of claim 1, wherein the reaction fuel is chosen from a gas, a plasma, a liquid, a supercritical fluid, or a solid.

8. The device of claim 1, wherein said one or more nanotubes are attached to a substrate chosen from plates, platelets, particles, fibers, ribbons or combinations thereof.

9. The device of claim 8, wherein said substrate comprises a material chosen from fused silica, quartz, metals, ceramics, allotropes of carbon, or any combination thereof.

10. The device of claim 1, wherein said one or more nanotubes form an array of aligned nanotubes, a network of interconnected nanotubes, or combinations thereof.

11. The device of claim 10, further comprising fibers chosen from quartz, carbon ceramic, metal and combinations thereof.

12. The device of claim 1, wherein said material for absorbing energetic particles is a fluid.

13. The device of claim 12, wherein said material for absorbing energetic particles is a molten metal.

14. The device of claim 13, wherein said molten metal is comprised of sodium, lithium, beryllium, mercury or combinations thereof.

15. The device of claim 13, wherein the energy transfer system further includes a gas permeable filter which is permeable to isotopes of hydrogen or helium or both, wherein one side of said filter is in contact with the molten metal and another side is in contact with a gas collection system.

16. The device of claim 15, wherein said metal filter comprises palladium, platinum, titanium, or combinations thereof.

17. The device of claim 1, wherein the reaction fuel is located within the one or more nanotubes.

18. The device of claim 1, wherein said source of activation energy is sufficient to form an electric current, a magnetic field, electromagnetic energy, ionizing radiation or combinations thereof.

19. The device of claim 18, wherein said source of activation energy is chosen from filaments, x-ray machines, antennas, magnets, accelerating electrode systems, ionizers, power supplies, capacitors, Van De Graaff generators, nanotube particle generators, lasers, microwave generators, ohmic heating elements and combinations thereof.

20. The device of claim 1, wherein said one or more nanotubes comprise carbon nanotubes.

21. The device of claim 20, wherein said carbon nanotubes are multi-walled, single walled, bamboo, spiral, and combinations there of.

22. The device of claim 13, wherein the said molten metal transfers thermal energy to a secondary thermal transport fluid.

23. The device of claim 13, wherein the molten metal at least partially surrounds the reaction vessel, said device further comprising a heat exchanger to transfer thermal energy from the molten metal to water for the production of steam.

24. The device of claim 23, further comprising a steam generator to produce power.

25. A method of generating thermal energy, from a nuclear transmutation reaction, said method comprising:
contacting, in a reaction vessel capable of sustaining a nuclear transmutation reaction, reaction fuel with one or more nanotubes;
adding energy to the reaction fuel and nanotube containing element to generate energetic particles;
absorbing said energetic particles with an energy absorption fluid in amount sufficient to increase the thermal energy of the energy absorption fluid; and
transferring, via a heat exchanger, the thermal energy of the energy absorption fluid to a working fluid.

26. The method of claim 25, wherein the energy absorption fluid comprises molten metal and the working fluid comprises water.

27. The method of claim 26, further comprising generating steam by transferring thermal energy from the molten metal to the water.
